(19) United States
(12) Patent Application Publication
(10) Pub. No.: US 2008/0101468 A1
(43) Pub. Date: May 1, 2008

(54) Test system of digital video data and semiconductor device

(76) Inventor: Kazunobu Ishikawa, Osaka (JP)

Correspondence Address: MCDERMOTT WILL & EMERY LLP, 600 13TH STREET, NW, WASHINGTON, DC, 20005-3096, US

(21) Appl. No.: 11/890,478

(22) Filed: Aug. 7, 2007

(30) Foreign Application Priority Data
Nov. 1, 2006 (JP) 2006-298061

(51) Int. Cl. H04B 1/66

(52) U.S. Cl. 375/240.12

(57) ABSTRACT

The digital video data test system includes a semiconductor device to be tested and a digital video data test device. In the semiconductor device, a clock frequency division section divides the frequency of a digital video clock to generate a frequency-divided clock. A timing signal generation section generates a timing signal synchronizing with the frequency-divided clock using a sync signal in digital video data. A code holding section outputs a generated code generated by a code generation section to the digital video data test device in synchronization with the timing signal and the frequency-divided clock.

### CROSS-REFERENCE TO RELATED APPLICATIONS

This application claims priority under 35 U.S.C. §119 on Patent Application No. 2006-298061 filed in Japan on Nov. 1, 2006, the entire contents of which are hereby incorporated by reference.

### BACKGROUND OF THE INVENTION

The present invention relates to a semiconductor device handling digital video data and a digital video data test system for detecting an electrical failure of the semiconductor device.

Japanese Laid-Open Patent Publication No. 2006-128905 discloses a digital video data test system and test device, in which a code uniquely defined from digital video data is generated inside a semiconductor device to be tested, and the generated code is compared with an expected value code inside or outside the semiconductor device, to thereby test the semiconductor device.

FIG. 16 is a block diagram showing the entire configuration of a conventional digital video data test system.

In FIG. 16, a stream data generation device 19 outputs stream data 26. A semiconductor device 4, which is an object to be tested, includes: a video decoder 18 for processing the stream data 26 to generate digital video data 2; and a code generation section 11 for generating a code (generated code) 21 uniquely defined from the digital video data 2.

A digital video data test device 1 includes: an image change point detection section 14 for detecting a temporal change in an image represented by the digital video data 2 based on the generated code 21 and outputting an image change point detection signal 22; an expected value storage section 12 for storing therein an expected value code 24; and a comparison section 13 for comparing the generated code 21 with the expected value code 24 and holding or outputting a comparison result 3.

A test method for digital video data using the digital video data test device described above will be described.

The stream data 26 outputted from the stream data generation device 19 is inputted into the semiconductor device 4, in which the video decoder 18 processes the stream data and outputs the resultant digital video data 2. Thereafter, the code generation section 11 generates the generated code 21 from the digital video data 2 and outputs the generated code 21 outside the semiconductor device 4.

The generated code 21 is then inputted into the digital video data test device 1, in which the image change point detection section 14 and the comparison section 13 receive the generated code 21. The image change point detection section 14 observes a temporal change in the generated code 21, to output the image change point detection signal 22 to the comparison section 13 at the time point of an image change. The comparison section 13 also receives the expected value code 24 stored in the expected value storage section 12.

The comparison section 13 sequentially compares the generated code 21 with the expected value code 24 and holds or outputs externally the comparison result 3.

FIG. 17 is a block diagram showing the entire configuration of another conventional digital video data test system.

The digital video data test system of FIG. 17 is different from the conventional digital video data test system of FIG. 16 in that the digital video data test device 1 includes: a designated code storage section 15 for storing therein a designated code 23 at the time point of start of the test; and a designated code detection section 16 for detecting agreement between the generated code 21 and the designated code 23 and outputting a designated code detection signal 25. The other components are the same as those in the conventional digital video data test system of FIG. 16, and thus description thereof is omitted here.

In the digital video data test system of FIG. 17, the comparison section 13 sequentially compares the generated code 21 with the expected value code 24 using the designated code detection signal 25 outputted from the designated code detection section 16 at the time point of detection of agreement between the designated code 23 and the generated code 21, in place of the image change point detection signal 22 in FIG. 16.

FIGS. 18 and 19 are block diagrams showing other conventional digital video data test systems.

The digital video data test systems of FIGS. 18 and 19 are different from the digital video data test systems of FIGS. 16 and 17 only in that the digital video data test device 1 is included inside a semiconductor device 5. The other configurations of the digital video data test systems of FIGS. 18 and 19 are the same as those of the digital video data test systems of FIGS. 16 and 17, respectively, and thus description thereof is omitted here.

The conventional digital video data test systems described above however have the following problems. The digital video data test systems of FIGS. 16 and 17 are required to specifically establish a method for outputting the generated code 21 generated by the code generation section 11 at low speed and a method for generating a clock signal and various types of timing signal for operating the digital video data test device 1.

The code generation section 11 must be initialized every occurrence of test timing. Since this initialization is conventionally made with a fixed value, one cycle of the digital video data 2 required for the initialization fails to be reflected by the next generated code 21. If an error occurs in the digital video data 2 at the timing of the initialization, therefore, the error will not be detected.

For the detection of an image change point, the generated code 21 must be generated for each video field, to allow detection of an image change point or comparison of the generated code with the designated code. It is therefore conventionally required to compare the generated code 21 with the expected value code for each video field, which is low in precision, or establish a method for detecting an image change point or a method for designating a designated code using the generated code generated for each unit shorter than the video field.

In the digital video data test systems of FIGS. 18 and 19, in which exclusive circuits must be mounted in the semiconductor device 5, it has been desired to reduce the area of such exclusive circuits.

For example, in the comparison of the generated code 21 generated every occurrence of test timing with the expected value code 24, it is necessary to have a memory element for temporarily holding data of a size of “length of generated code×bus width of digital video data”. If the length of the generated code is 16 bits and the bus width of the digital video data is 30 bits, a memory element having a capacity of “16×30=480 bits” will be required.

### SUMMARY OF THE INVENTION

An object of the present invention is providing a digital video data test system in which a method for generating various signals to be supplied from a semiconductor device to a digital video data test device is specifically established.

Another object of the present invention is permitting flexible setting of the test unit depending on the required test precision and test time.

A yet another object of the present invention is minimizing increase in circuit area resulting from mounting of an exclusive circuit for testing in a semiconductor device to be tested.

To attain the above objects, according to the present invention, the semiconductor device is newly provided with a clock frequency division section to permit output of a low-speed frequency-divided clock, generated code and timing signal.

In the clock frequency division section, the phase of the frequency-divided clock may be initialized every occurrence of test timing, and also measures may be taken to avoid generation of a pulse shorter than the half cycle of the frequency-divided clock, to ensure that the length of a given test unit is not limited by the length of the frequency-divided clock.

The code generation section may be provided with a code generation initialization section, which initializes the code generation section every occurrence of test timing using a value reflecting the digital video data at the initialization timing, so that an error can be detected even if the initialization timing coincides with error timing.

The timing of code generation for each digital video data unit may be shifted, to permit sharing of a memory element for temporary data holding among digital video data units. This greatly reduces the area of the memory element.

A test timing initialization section may be provided to initialize the phase of the test timing with respect to field boundary timing every occurrence of field boundary timing, to thereby permit comparison of a generated code with an expected value code by a given data length.

The image change point detection section detects a change in an image, or the designated code detection section detects a field designated with a designated code, using a generated code generated every occurrence of test timing, so that a field at which the test should be started can be specified from a generated code generated every occurrence of test timing.

A microcomputer embedded in the semiconductor device may be used for execution of read of an expected value code from an external memory element, comparison between the generated code and the expected value code, or both the read and the comparison, to permit reduction in the number of exclusive circuits to be mounted in the semiconductor device.

Testing of the semiconductor device may be made including a substrate on which the semiconductor device is mounted.

An expected value code input section capable of receiving an expected value code from a remote position and a test control section for executing the test at designated timing may also be provided, to implement a system permitting self-diagnosis.

Specifically, the digital video data test system of the present invention includes a semiconductor device and a digital video data test device. The semiconductor device includes: a code generation section for generating a generated code uniquely defined from inputted digital video data; a clock frequency division section for dividing the frequency of a clock to generate a frequency-divided clock; a timing signal generation section for generating a timing signal synchronizing with the frequency-divided clock using a sync signal in the digital video data; and a code holding section for outputting the generated code in synchronization with the timing signal and the frequency-divided clock. The semiconductor device outputs the timing signal, the generated code and the frequency-divided clock externally. The digital video data test device, receiving the timing signal, the generated code and the frequency-divided clock from the semiconductor device, includes: an image change point detection section for analyzing the generated code generated by the code generation section to detect an image change point at which an image represented by the digital video data temporally changes; an expected value storage section for storing therein an expected value code; and a comparison section for starting comparison between the generated code and the expected value code at and after the time point of detection of the image change point. The digital video data test device tests the semiconductor device by processing the generated code.

In an embodiment of the digital video data test system of the invention, the semiconductor device further includes a phase initialization section for initializing the phase of the frequency-divided clock every occurrence of specific timing defined by the timing signal, and the phase initialization section sets the signal level of the frequency-divided clock to be the same level as that immediately before the initialization during at least a half cycle of the clock from immediately after the initialization.

In another embodiment of the digital video data test system of the invention, the semiconductor device further includes a code generation initialization section for initializing the code generation section in synchronization with the timing signal, and the code generation initialization section initializes the code generation section with an initial value reflecting digital video data in an initialization cycle.

In yet another embodiment of the digital video data test system of the invention, the semiconductor device further includes a generated code holding section for holding the generated code until outputting the generated code, and when a plurality of code generation sections exist, the generated code holding section sequentially holds generated codes generated by the respective code generation sections in synchronization with the timing signal and the frequency-divided clock signal.

In yet another embodiment of the digital video data test system of the invention, the semiconductor device further includes a test timing initialization section for initializing timing of occurrence of test timing indicating the timing at which the generated code is compared with the expected value code, in the timing signal, every occurrence of field timing indicating the timing on a field-by-field basis in the timing signal.

In yet another embodiment of the digital video data test system of the invention, the digital video data test device further includes: a field-specific code generation section for generating a field-specific code from the inputted generated code every occurrence of test timing in the timing signal; and a field-specific code comparing section for comparing a field-specific code generated in the current field with a field-specific code generated in the second immediately preceding field, among field-specific codes generated by the field-specific code generation section, and the comparison section starts comparison between the generated code and the expected value code at the time point of detection of disagreement between the two field-specific codes.

In yet another embodiment of the digital video data test system of the invention, the semiconductor device is mounted on a substrate, and the generated code is transmitted from the semiconductor device to the digital video data test device via the substrate.

In yet another embodiment of the digital video data test system of the invention, the system further includes: an expected value code transmission device for transmitting a given expected value code; an expected value code input section for receiving the expected value code from outside; and a test control section for executing testing at designated timing.

Alternatively, the digital video data test system of the present invention includes a semiconductor device and a digital video data test device. The semiconductor device includes: a code generation section for generating a generated code uniquely defined from inputted digital video data; a clock frequency division section for dividing the frequency of a clock to generate a frequency-divided clock; a timing signal generation section for generating a timing signal synchronizing with the frequency-divided clock using a sync signal in the digital video data; and a code holding section for outputting the generated code in synchronization with the timing signal and the frequency-divided clock. The semiconductor device outputs the timing signal, the generated code and the frequency-divided clock externally. The digital video data test device, receiving the timing signal, the generated code and the frequency-divided clock from the semiconductor device, includes: a designated code storage section for storing therein a designated code; a designated code detection section for detecting agreement between the generated code generated by the code generation section and the designated code; an expected value storage section for storing therein an expected value code; and a comparison section for starting comparison between the generated code and the expected value code at and after the time point of detection of agreement between the generated code and the designated code. The digital video data test device tests the semiconductor device by processing the generated code.

In an embodiment of the digital video data test system of the invention, the semiconductor device further includes a phase initialization section for initializing the phase of the frequency-divided clock every occurrence of specific timing defined by the timing signal, and the phase initialization section sets the signal level of the frequency-divided clock to be the same level as that immediately before the initialization during at least a half cycle of the clock from immediately after the initialization.

In another embodiment of the digital video data test system of the invention, the semiconductor device further includes a code generation initialization section for initializing the code generation section in synchronization with the timing signal, and the code generation initialization section initializes the code generation section with an initial value reflecting digital video data in an initialization cycle.

In yet another embodiment of the digital video data test system of the invention, the semiconductor device further includes a generated code holding section for holding the generated code until outputting the generated code, and when a plurality of code generation sections exist, the generated code holding section sequentially holds generated codes generated by the respective code generation sections in synchronization with the timing signal and the frequency-divided clock signal.

In yet another embodiment of the digital video data test system of the invention, the semiconductor device further includes a test timing initialization section for initializing timing of occurrence of test timing indicating the timing at which the generated code is compared with the expected value code, in the timing signal, every occurrence of field timing indicating the timing on a field-by-field basis in the timing signal.

In yet another embodiment of the digital video data test system of the invention, the digital video data test device further includes: a field-specific code generation section for generating a field-specific code from the inputted generated code every occurrence of test timing in the timing signal; and a designated field-specific code holding section for holding a designated field-specific code, and the comparison section starts comparison between the generated code and the expected value code at the time point of detection of agreement between the field-specific code and the designated field-specific code.

In yet another embodiment of the digital video data test system of the invention, the semiconductor device is mounted on a substrate, and the generated code is transmitted from the semiconductor device to the digital video test device via the substrate.

In yet another embodiment of the digital video data test system of the invention, the system further includes: an expected value code transmission device for transmitting a given expected value code; an expected value code input section for receiving the expected value code from outside; and a test control section for executing testing at designated timing.

The semiconductor device of the present invention includes: a code generation section for generating a generated code uniquely defined from inputted digital video data; a clock frequency division section for dividing the frequency of a clock to generate a frequency-divided clock; a timing signal generation section for generating a timing signal synchronizing with the frequency-divided clock using a sync signal in the digital video data; a code holding section for outputting the generated code in synchronization with the timing signal and the frequency-divided clock; an image change point detection section for analyzing the generated code generated by the code generation section to detect an image change point at which an image represented by the digital video data temporally changes; an expected value storage section for storing therein an expected value code; an embedded microcomputer for executing read of the expected value code into the expected value storage section; and a comparison section for starting comparison between the generated code and the expected value code at and after the time point of detection of the image change point.

In an embodiment of the semiconductor device of the invention, the embedded microcomputer serves as the comparison section.

In another embodiment of the semiconductor device of the invention, the embedded microcomputer serves as the comparison section, and the embedded microcomputer reads the generated code and the expected value code and compares the generated code with the expected value code.

Alternatively, the semiconductor device of the present invention includes: a code generation section for generating a generated code uniquely defined from inputted digital video data; a clock frequency division section for dividing the frequency of a clock to generate a frequency-divided clock; a timing signal generation section for generating a timing signal synchronizing with the frequency-divided clock using a sync signal of the digital video data; a code holding section for outputting the generated code in synchronization with the timing signal and the frequency-divided clock; a designated code storage section for storing therein a designated code; a designated code detection section for detecting agreement between the generated code generated by the code generation section and the designated code; an expected value storage section for storing therein an expected value code; an embedded microcomputer for executing read of the expected value code into the expected value storage section; and a comparison section for starting comparison between the generated code and the expected value code at and after the time point of detection of agreement between the generated code and the designated code.

In an embodiment of the semiconductor device of the invention, the embedded microcomputer serves as the comparison section.

In another embodiment of the semiconductor device of the invention, the embedded microcomputer serves as the comparison section, and the embedded microcomputer reads the generated code and the expected value code and compares the generated code with the expected value code.

### BRIEF DESCRIPTION OF THE DRAWINGS

FIG. 1 is a block diagram of the entire configuration of a digital video data test system of Embodiment 1 of the present invention.

FIG. 2 is a block diagram of the entire configuration of a digital video data test system of Embodiment 2 of the present invention.

FIGS. 3A and 3B are diagrammatic views of the phase relationship among clocks in the semiconductor device of the digital video data test system of FIG. 2.

FIG. 4 is a block diagram of the entire configuration of a digital video data test system of Embodiment 3 of the present invention.

FIG. 5 is a block diagram of the entire configuration of a digital video data test system of Embodiment 4 of the present invention.

FIG. 6 is a diagrammatic view of timing of copying of a generated code in the digital video data test system.

FIG. 7 is a block diagram of the entire configuration of a digital video data test system of Embodiment 5 of the present invention.

FIG. 8 is a diagrammatic view of the positional relationship between field timing and test timing in the digital video data test system of FIG. 7.

FIG. 9 is a block diagram of the entire configuration of a digital video data test system of Embodiment 6 of the present invention.

FIG. 10 is a block diagram of the entire configuration of a digital video data test system of Embodiment 7 of the present invention.

FIG. 11 is a block diagram of the entire configuration of a semiconductor device of Embodiment 8 of the present invention.

FIG. 12 is a block diagram of the entire configuration of a semiconductor device of Embodiment 9 of the present invention.

FIG. 13 is a block diagram of the entire configuration of a semiconductor device of Embodiment 10 of the present invention.

FIG. 14 is a block diagram of the entire configuration of a digital video data test system of Embodiment 11 of the present invention.

FIG. 15 is a block diagram of the entire configuration of a digital video data test system of Embodiment 12 of the present invention.

FIG. 16 is a block diagram of the entire configuration of a conventional digital video data test system.

FIG. 17 is a block diagram of the entire configuration of another conventional digital video data test system.

FIG. 18 is a block diagram of the entire configuration of a conventional semiconductor device.

FIG. 19 is a block diagram of the entire configuration of another conventional semiconductor device.

### DESCRIPTION OF THE PREFERRED EMBODIMENTS

Hereinafter, preferred embodiments of the present invention will be described with reference to the accompanying drawings. Note that the embodiments to follow are merely illustrative and are not meant to restrict the present invention.

### Embodiment 1

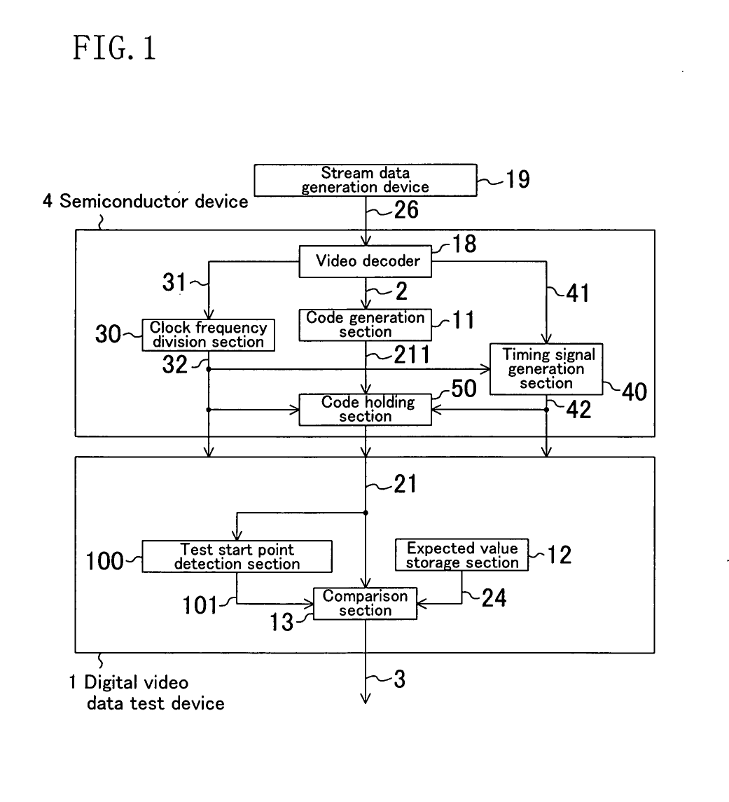

FIG. 1 is a block diagram showing the entire configuration of a digital video data test system of Embodiment 1 of the present invention.

In FIG. 1, a stream data generation device 19 outputs stream data 26. A semiconductor device 4, which is an object to be tested, processes the stream data 26 and outputs a generated code 21. A digital video data test device 1 processes the generated code 21 to test the semiconductor device 4. The semiconductor device 4 and the digital video data test device 1 constitute the digital video data test system.

The semiconductor device 4 includes: a video decoder 18 for processing the stream data 26 to generate digital video data 2; a code generation section 11 for generating a code (generated code) 211 uniquely defined from the digital video data 2; a clock frequency division section 30 for dividing the frequency of a digital video clock 31 to generate a frequency-divided clock 32; a timing signal generation section 40 for generating a timing signal 42 synchronizing with the frequency-divided clock 32 from a sync signal 41 in the digital video data 2; and a code holding section 50 for synchronizing the generated code 211 with the timing signal 42 and the frequency-divided clock 32 to output the resultant code as a generated code 21.

The digital video data test device 1 includes: a test start point detection section (image change point detection section) 100 for processing the generated code 21 to output a test start timing signal 101; an expected value storage section 12 for storing therein an expected value code 24; and a comparison section 13 for comparing the generated code 21 with the expected value code 24.

Hereinafter, a test method for digital video data using the digital video data test system described above will be described.

The stream data 26 from the stream data generation device 19 is inputted into the semiconductor device 5 as the object to be tested, in which the video decoder 18 processes the stream data 26 to generate the digital video data 2. The digital video data 2 is inputted into the code generation section 11, which outputs the generated code 211 uniquely defined from the digital video data 2.

The digital video clock 31 outputted from the video decoder 18 is inputted into the clock frequency division section 30, which frequency-divides the digital video clock 31 to generate the frequency-divided clock 32.

The sync signal 41 outputted from the video decoder 18 is inputted into the timing signal generation section 40, which generates the timing signal 42 synchronizing with the frequency-divided clock 32.

The generated code 211 is inputted into the code holding section 50, which sequentially outputs the generated code 21 in synchronization with the frequency-divided clock 32 every occurrence of test timing defined by the timing signal 42.

The generated code 21 is inputted into the digital video data test device 1, in which the test start point detection section 100 and the comparison section 13 receive the generated code 21. The test start point detection section 100 detects timing at which the test should be started (image change point) based on the generated code 21, to generate the test start timing signal 101, and outputs the generated timing signal 101 to the comparison section 13.

The comparison section 13, which receives not only the generated code 21 but also the expected value code 24 stored in the expected value storage section 12, sequentially compares the generated code 21 with the expected value code 24 at and after the time point of reception of the test start timing signal 101, to determine whether the semiconductor device 4 is conforming or nonconforming, and outputs the comparison result 3.

Note that the digital video data test device 1 uses the inputted frequency-divided clock 32 as the equivalent of the clock signal in the digital video data 2 (digital video clock) and the inputted timing signal 42 as the equivalent of the vertical sync signal and horizontal sync signal in the digital video data 2.

The generated code 211 generated by the code generation section 11 is a cyclic redundancy check (CRC) code, for example, in which the same code will inevitably be generated from the same data and a completely different code will be generated from different data.

As described above, according to the digital video data test system of this embodiment, all the signals to be inputted into the digital video data test device 1 from the semiconductor device 4, that is, the frequency-divided clock 32, the timing signal 42 synchronizing with the frequency-divided clock 32 and the generated code 21 synchronizing with the frequency-divided clock 32, can be transmitted at low speed.

### Embodiment 2

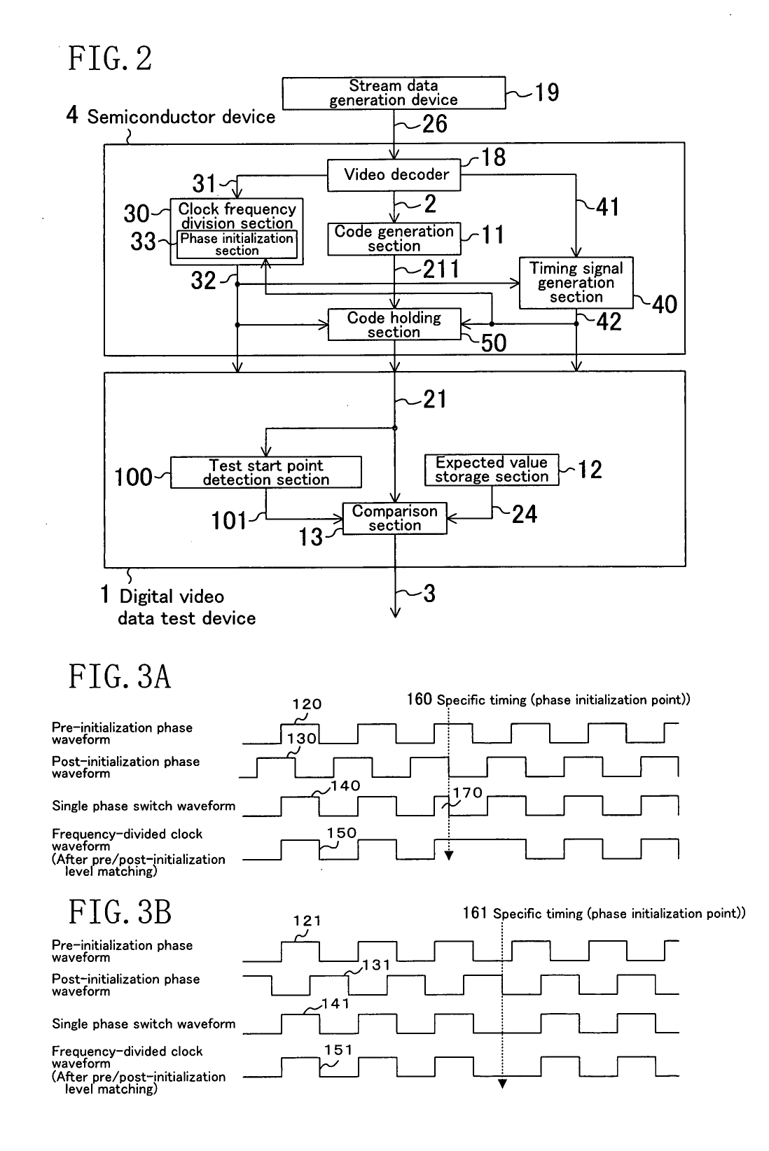

FIG. 2 is a block diagram showing the entire configuration of a digital video data test system of Embodiment 2 of the present invention.

The digital video data test system of this embodiment is different from that of Embodiment 1 described above in that a phase initialization section 33 is additionally provided. If the test timing interval is not an integral multiple of the frequency-divided clock, the phase of the frequency-divided clock must be initialized. In this case, the signal level may differ between before and after the initialization, and this may cause generation of a pulse having a length shorter than the half cycle of the frequency-divided clock. The phase initialization section 33 is provided to avoid such an occurrence. The other part of the configuration is the same as that of Embodiment 1. The same components are therefore denoted by the same reference numerals and only the point different from Embodiment 1 will be described.

In the semiconductor device 4, the clock frequency division section 30 receives the timing signal 42 and is provided with the phase initialization section 33 for initializing the phase of the clock every occurrence of test timing included in the timing signal 42.

A test method for digital video data using the digital video data test system described above will be described focusing only on the point different from Embodiment 1.

FIGS. 3A and 3B are diagrammatic views showing phase waveforms of clocks in the semiconductor device of the digital video data test system of this embodiment.

In FIGS. 3A and 3B, shown are pre-initialization phase waveforms 120 and 121, post-initialization phase waveforms 130 and 131, simple phase switch waveforms 140 and 141 and processed frequency-divided clock waveforms 150 and 151 subjected to pre/post-initialization level matching. The phase initialization section 33 initializes the phase of the frequency-divided clock 32 at specific timing 160, 161. The specific timing 160, 161, included in the timing signal 42, is timing at which the test timing is received.

In FIG. 3A, the post-initialization phase waveform 130 is deviated from the pre-initialization phase waveform 120. When the signal level immediately after the initialization is “L”, a pulse 170 shorter than the half cycle length of the frequency-divided clock 32 will occur if the phase is simply initialized. To overcome this problem, as shown by the processed frequency-divided clock waveform 150, the level “H” that is the signal level immediately before the phase initialization is maintained during the half cycle length at shortest. The length during which the pre-initialization signal level “H” is maintained may be a time period equal to or longer than the half cycle length, and naturally may be a time period of an integral multiple of the half cycle length.

In FIG. 3B, no pulse shorter than the half cycle length of the frequency-divided clock 32 occurs in the simple phase switch waveform 141 in the phase relationship between the pre-initialization phase waveform 121 and the post-initialization phase waveform 131. In this case, therefore, the simple phase switch waveform 141 may be used as it is as the frequency-divided clock waveform 151. Naturally, the level “L” that is the signal level immediately before the phase initialization may be maintained during the half cycle length or longer, and for the time period of an integral multiple of the half cycle length.

The case of the signal level being “L” immediately after the phase initialization was exemplified in the above description. Substantially the same procedure as that described above may also be adopted for the case of the signal level being “H” immediately after the phase initialization although “H” and “L” are reversed.

According to the digital video data test system of this embodiment, in which the test start point detection section 100 operates under the premise that the same generated code is generated from the same field, the phase of the frequency-divided clock 32 can be kept fixed with respect to the sync signal 41 at all times. Also, occurrence of a pulse shorter than the half cycle length in the waveform of the frequency-divided clock 32 can be avoided.

### Embodiment 3

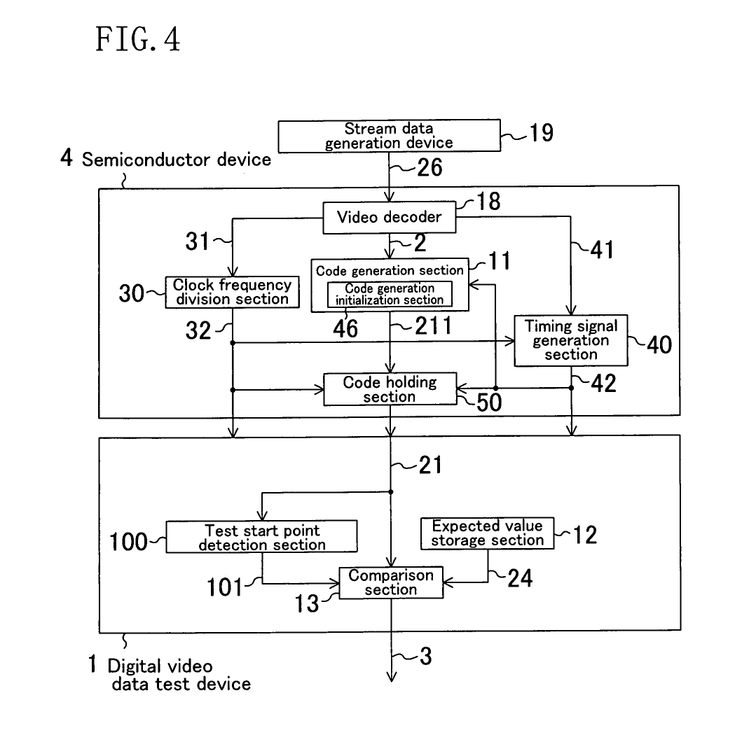

FIG. 4 is a block diagram showing the entire configuration of a digital video data test system of Embodiment 3 of the present invention.

The digital video data test system of this embodiment is different from that of Embodiment 1 described above in that a code generation initialization section 46 is additionally provided. The code generation initialization section 46 initializes the code generation section 11 with an initialization value reflecting the digital video data 2 in the initialization cycle, in synchronization with the timing signal 42. The other part of the configuration is the same as that of Embodiment 1. The same components are therefore denoted by the same reference numerals and only the point different from Embodiment 1 will be described.

In the semiconductor device 4, the code generation section 11 receives the timing signal 42 and is provided with the code generation initialization section 46 that initializes the code generation section 11 with an initialization value reflecting the digital video data 2 in the initialization cycle every occurrence of test timing included in the timing signal 42.

A test method for digital video data using the digital video data test system described above will be described focusing only on the point different from Embodiment 1.

The code generation section 11 is initialized after copying the generated code 211 to the code holding section 50 every occurrence of test timing included in the timing signal 42. In this embodiment, the code generation section 11 is initialized with the generated code 211 obtained from the digital video data 2 in the initialization cycle as a formal initialization value, in place of a fixed value predetermined as a tentative initialization value.

As described above, according to the digital video data test system of this embodiment, an error that may be contained in the digital video data 2 in the initialization cycle of the code generation section 11 can be detected without fail.

### Embodiment 4

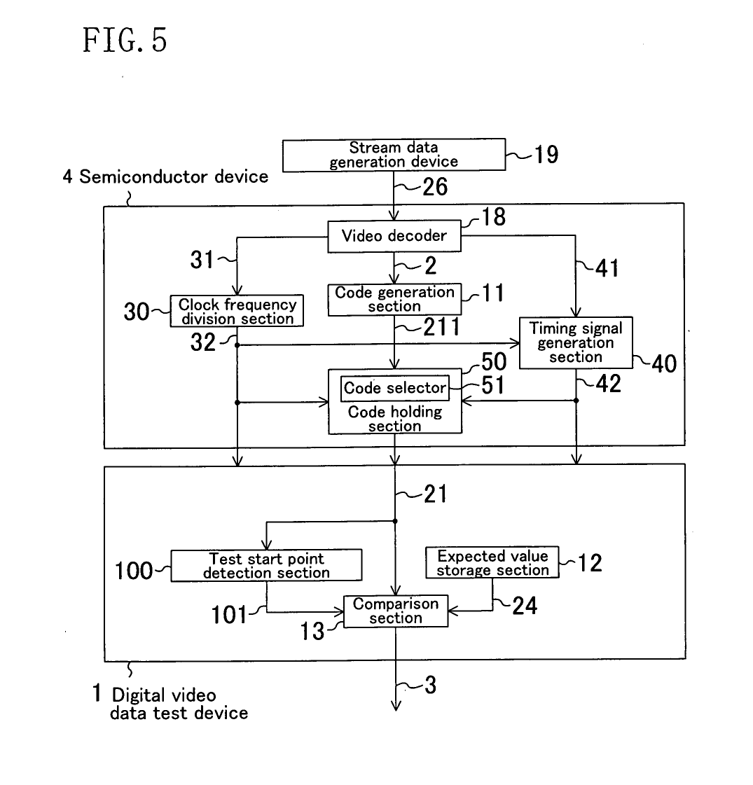

FIG. 5 is a block diagram showing the entire configuration of a digital video data test system of Embodiment 4 of the present invention.

The digital video data test system of this embodiment is different from that of Embodiment 1 described above in that a code selector (generated code holding section) 51 is provided inside the code holding section 50. In the case that code generators are provided for the respective bits of digital video data buses, the code selector 51 sequentially copies generated codes 211 to the comparator 13 in synchronization with the frequency-divided clock at and after generation of the test start timing signal 101. The other part of the configuration is the same as that of Embodiment 1. The same components are therefore denoted by the same reference numerals and only the point different from Embodiment 1 will be described.

In the semiconductor device 4, the code selector 51 is provided inside the code holding section 50 and, in the case that code generators are provided for the respective bits of digital video data buses, sequentially copies generated codes 211 in synchronization with the frequency-divided clock 32 at and after generation of the test start timing signal 101.

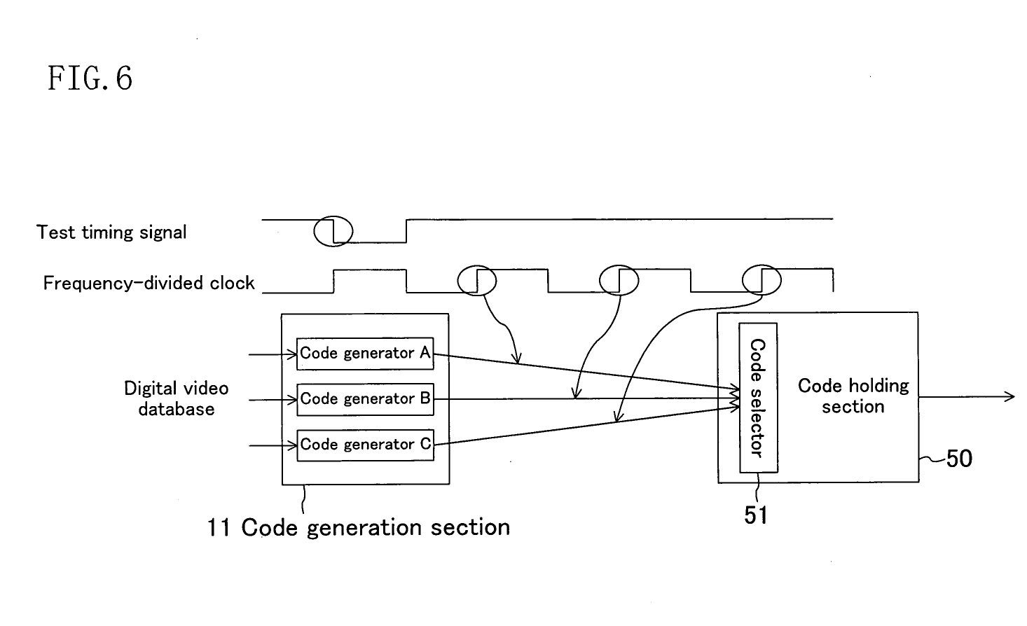

A test method for digital video data using the digital video data test system described above will be described with reference to FIG. 6. Herein only the point different from Embodiment 1 will be discussed.

FIG. 6 is a diagrammatic view showing timing of copying of generated codes in the digital video data test system of this embodiment.

The code selector 51 sequentially copies generated codes, outputted from code generators A, B and C in the code generation section 11 in correspondence with the respective bits of the digital video data, to the comparison section 13 in synchronization with the frequency-divided clock 32 at and after generation of the test start timing signal 101.

As described above, according to the digital video data test system of this embodiment, the code holding section 50, which conventionally must be prepared to correspond to the bus width of the digital video data, can be shared among a plurality of digital video data buses. This can greatly reduce the circuit area.

### Embodiment 5

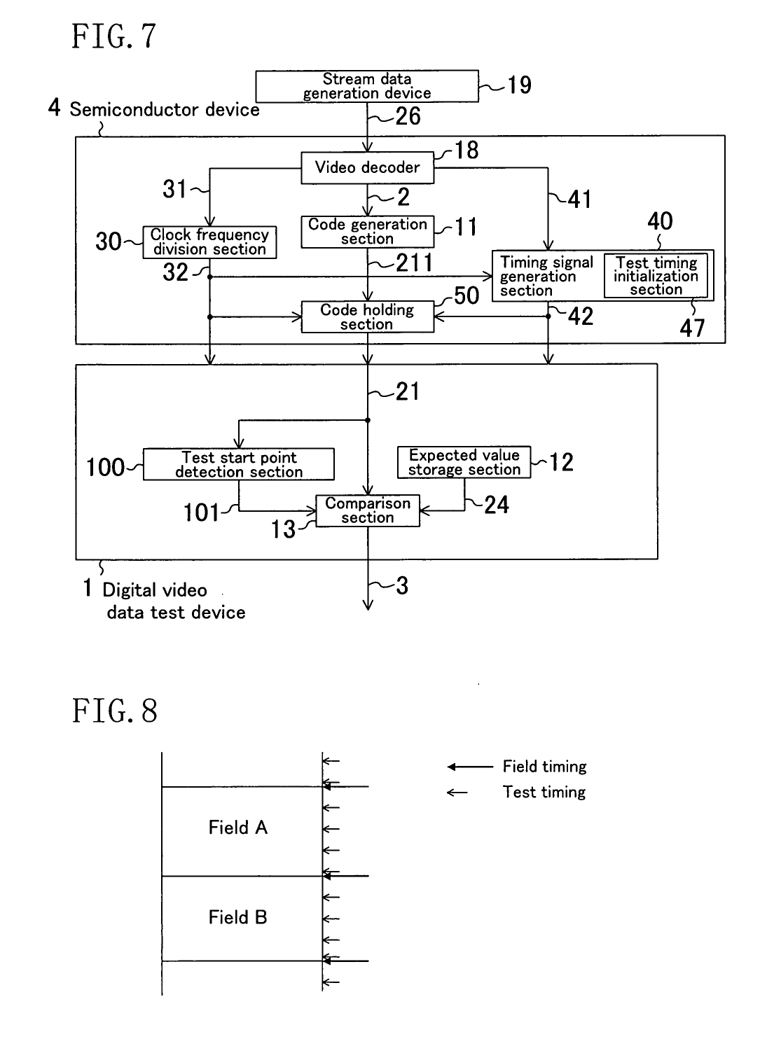

FIG. 7 is a block diagram showing the entire configuration of a digital video data test system of Embodiment 5 of the present invention.

The digital video data test system of this embodiment is different from that of Embodiment 1 described above in that a test timing initialization section 47 is provided in the semiconductor device 4. The test timing initialization section 47 initializes the timing of occurrence of test timing included in the timing signal 42 every time field timing occurs. The field timing is timing occurring field by field in the timing signal 42. The other part of the configuration is the same as that of Embodiment 1. The same components are therefore denoted by the same reference numerals and only the point different from Embodiment 1 will be described.

In the semiconductor device 4, the test timing initialization section 47 is provided inside the timing signal generation section 40, and initializes the timing of occurrence of test timing included in the timing signal 42 every time field timing included in the timing signal 42 occurs.

Hereinafter, a test method for digital video data using the digital video data test system described above will be described with reference to FIG. 8. Herein only the point different from Embodiment 1 will be discussed.

FIG. 8 is a diagrammatic view showing the positional relationship between the field timing and the test timing in the digital video data test system of this embodiment.

The timing signal generation section 40 generates the field timing synchronizing with the frequency-divided clock 32 every field boundary and the test timing having fixed timing intervals. The test timing initialization section 47 initializes the count of the interval of the test timing to a fixed value in agreement with the field timing.

As described above, according to the digital video data test system of this embodiment, the position of the test timing from each occurrence of field timing is fixed irrespective of the field, and this can ensure the reproducibility of the generated code.

### Embodiment 6

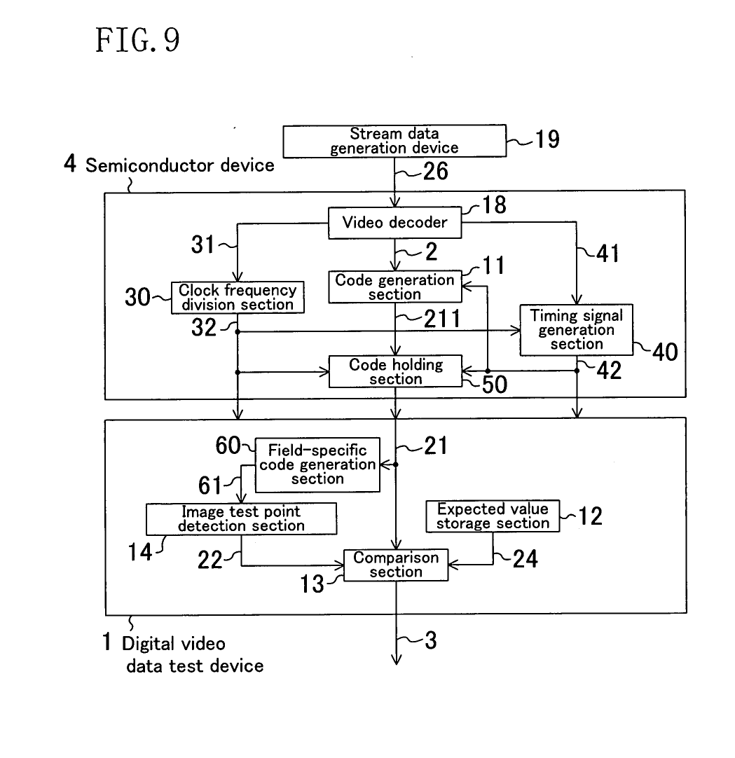

FIG. 9 is a block diagram showing the entire configuration of a digital video data test system of Embodiment 6 of the present invention.

The digital video data test system of this embodiment is different from that of Embodiment 1 described above in that an image test point detection section (field-specific code comparing section) 14 is provided in place of the test start point detection section 100 and a field-specific code generation section 60 is additionally provided. The other part of the configuration is the same as that of Embodiment 1. The same components are therefore denoted by the same reference numerals and only the point different from Embodiment 1 will be described.

The digital video data test device 1 includes: the field-specific code generation section 60 for generating a field-specific code 61 from generated codes 21 for each field; and the image test point detection section 14 for detecting an image start point by processing the field-specific code 61 and outputting an image start point detection signal 22. The image start point detection signal 22 is inputted into the comparison section 13 as the test start timing signal.

A test method for digital video data using the digital video data test system described above will be described. Herein only the point different from Embodiment 1 will be discussed.

The field-specific code generation section 60 generates the field-specific code 61 from generated codes 21 for each field. The image test point detection section 14 detects an image start point by processing the field-specific code 61 for one field and outputs the image start point detection signal 22 to the comparison section 13.

As described above, according to the digital video data test system of this embodiment, the generated code 21 for each test timing unit is compared between continuous field-specific codes 61, to thereby enable determination on whether or not the same field is continuing or whether or not a different field has started, and this permits reproducible testing.

Note that in the case of testing of interlaced digital video data, field data is different between the top field and the bottom field even in a still image. In determination of start of a different field, therefore, the field-specific code for the current field is compared with that for the second immediately preceding field, to detect an image start point and output the video start point detection signal 22.

### Embodiment 7

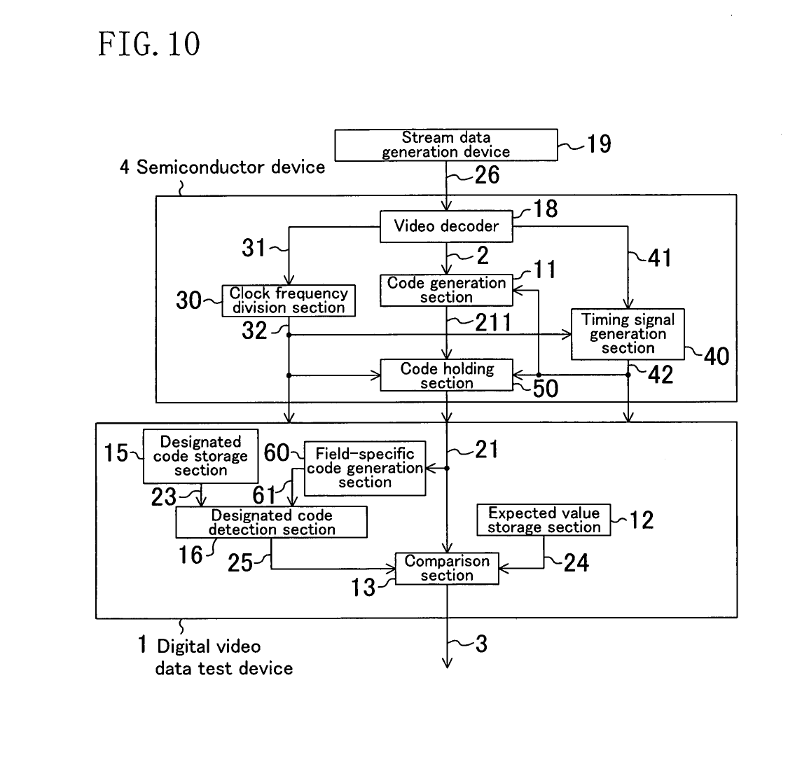

FIG. 10 is a block diagram showing the entire configuration of a digital video data test system of Embodiment 7 of the present invention.

The digital video data test system of this embodiment is different from that of Embodiment 1 described above in that a designated code detection section 16 is provided in place of the test start point detection section 100, and that the field-specific code generation section 60 and a designated code storage section (designated field-specific code holding section) 15 are additionally provided. The other part of the configuration is the same as that of Embodiment 1. The same components are therefore denoted by the same reference numerals and only the point different from Embodiment 1 will be described.

The digital video data test device 1 includes: the field-specific code generation section 60 for generating the field-specific code 61 from generated codes 21 for each field; the designated code storage section 15 for storing therein a designated code; and the designated code detection section 16. The designated code detection section 16 compares the field-specific code 61 with a designated code 23 outputted from the designated code storage section 15, and outputs a designated code detection signal 25 to the comparison section 13 as the test start timing signal.

A test method for digital video data using the digital video data test system described above will be described. Herein only the point different from Embodiment 1 will be discussed.

The field-specific code generation section 60 generates the field-specific code 61 from generated codes 21 for each field. The designated code detection section 16 compares the field-specific code 61 with the designated code 23 stored in the designated code storage section 15. Once these codes agree with each other, the designated code detection section 16 determines that an image start point has been detected and outputs the designated code detection signal 25 to the comparison section 13.

As described above, according to the digital video data test system of this embodiment, comparison of the generated code 21 for each test timing unit is made using continuous field-specific codes 61 and the designated code 15, to thereby enable determination on whether or not the same field is continuing or whether or not a different field has started, and this permits reproducible testing.

In the case of testing of interlaced digital video data, field data is different between the top field and the bottom field even in a still image. In determination of start of a different field, therefore, the field-specific code for the current field is compared with that for the second immediately preceding field.

### Embodiment 8

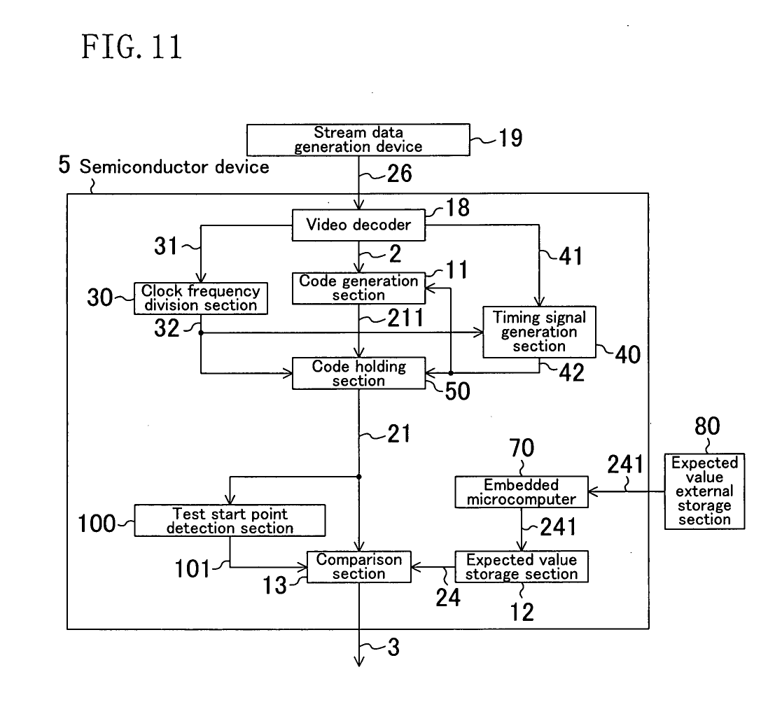

FIG. 11 is a block diagram showing the entire configuration of a semiconductor device of Embodiment 8 of the present invention.

In FIG. 11, a stream data generation device 19 that outputs stream data 26, a semiconductor device 5 and an expected value external storage section 80 are shown.

The semiconductor device 5 includes: a video decoder 18 for processing the stream data 26 to generate digital video data 2; a code generation section 11 for generating a generated code 211 uniquely defined from the digital video data 2; a clock frequency division section 30 for dividing the frequency of a digital video clock 31 to generate a frequency-divided clock 32; a timing signal generation section 40 for generating a timing signal 42 synchronizing with the frequency-divided clock 32 from a sync signal 41 in the digital video data 2; a code holding section 50 for synchronizing the generated code 211 with the timing signal 42 and the frequency-divided clock 32 to output the resultant code as a generated code 21; a test start point detection section (image change point detection section) 100 for processing the generated code 21 to output a test start timing signal 101; an expected value storage section 12 for storing therein an expected value code 24; and a comparison section 13 for comparing the generated code 21 with the expected value code 24.

Hereinafter, a test method for digital video data using the digital video data test system described above will be described.

The stream data 26 from the stream data generation device 19 is inputted into the semiconductor device 5 as the object to be tested, in which the video decoder 18 processes the stream data to generate the digital video data 2. The digital video data 2 is then inputted into the code generation section 11, which outputs the generated code 211 uniquely defined from the digital video data 2.

The digital video clock 31 outputted from the video decoder 18 is inputted into the clock frequency division section 30, which frequency-divides the digital video clock 31 to generate the frequency-divided clock 32.

The sync signal 41 outputted from the video decoder 18 is inputted into the timing signal generation section 40, which generates the timing signal 42 synchronizing with the frequency-divided clock 32.

The generated code 211 is inputted into the code holding section 50, which sequentially outputs the generated code 21 in synchronization with the frequency-divided clock 32 every occurrence of test timing defined by the timing signal 42.

The generated code 21 is inputted into the test start point detection section 100 and the comparison section 13. The test start point detection section 100 detects timing at which the test should be started (image change point) based on the generated code 21, to generate the test start timing signal 101, and outputs the generated test start timing signal 101 to the comparator 13.

The comparison section 13, which receives not only the generated code 21 but also the expected value code 24 stored in the expected value storage section 12, sequentially compares the generated code 21 with the expected value code 24 at and after the time point of reception of the test start timing signal 101, to determine whether the semiconductor device 5 is conforming or nonconforming, and outputs the comparison result 3.

In the expected value storage section 12, stored is an expected value code 241 read from the expected value external storage section 80 placed outside the semiconductor device 5. A microcomputer 70 embedded in the semiconductor device 5 controls the read of the expected value code from the expected value external storage section 80 into the expected value storage section 12.

As described above, according to the semiconductor device of this embodiment, in which the components of the digital video data test device 1 in Embodiment 1 are incorporated, the easiness of testing can be improved.

Also, since the expected value external storage section 80 is placed outside the semiconductor device 5, and the embedded microcomputer 70 used for control of the semiconductor device 5 is also used for read of the expected value code 241, increase in the area of the semiconductor device 5 can be suppressed.

### Embodiment 9

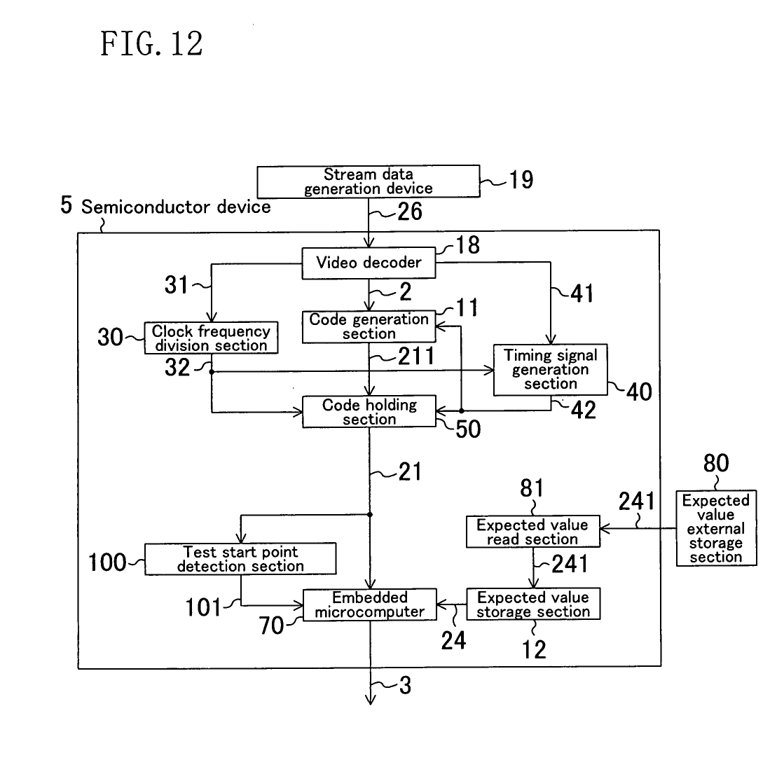

FIG. 12 is a block diagram showing the entire configuration of a semiconductor device of Embodiment 9 of the present invention.

The semiconductor device of this embodiment is different from that of Embodiment 8 described above in that an expected value read section 81 is used in place of the embedded microcomputer 70 for read of the expected value code 241 from the expected value external storage section 80 and that the embedded microcomputer 70 is used in place of the comparison section 13 for comparison of the generated code 21 with the expected value code 24. The other part of the configuration is the same as that of Embodiment 8. The same components are therefore denoted by the same reference numerals and only the different point will be described.

The semiconductor device 5 of this embodiment includes the expected value read section 81 to be used in place of the microcomputer 70 in Embodiment 8, and uses the microcomputer 70 in place the comparison section 13.

In a test method for digital video data using the semiconductor device 5 described above, the expected value read section 81 reads the expected value code 241 from the expected value external storage section 80, and the embedded microcomputer 70 compares the generated code 21 with the expected value code 24.

As described above, according to the semiconductor device of this embodiment, which includes the components of the digital video data test device 1 in Embodiment 1, the easiness of testing can be improved. Also, since the expected value external storage section 80 is placed outside the semiconductor device 5, and the embedded microcomputer 70 is used in place of the comparison section 13, increase in the area of the semiconductor device 5 can be suppressed.

### Embodiment 10

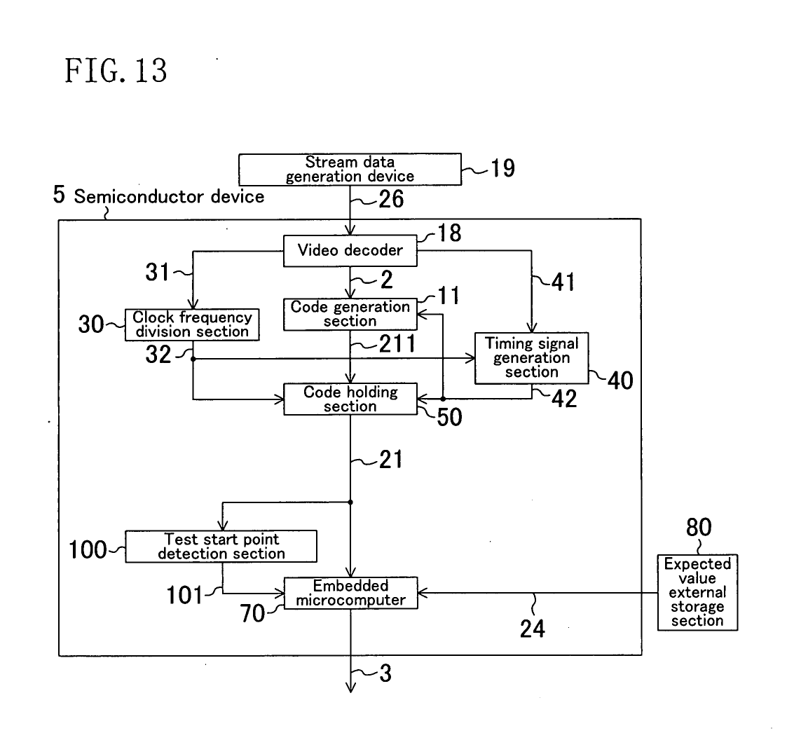

FIG. 13 is a block diagram showing the entire configuration of a semiconductor device of Embodiment 10 of the present invention.

The semiconductor device of this embodiment is different from that of Embodiment 8 described above in that the embedded microcomputer 70 is used in place of the comparison section 13. The other part of the configuration is the same as that of Embodiment 8. The same components are therefore denoted by the same reference numerals and only the different point will be described.

The semiconductor device 5 of this embodiment uses the embedded microcomputer 70 in place the comparison section 13 in Embodiment 8, and is not provided with the expected value storage section 12. The microcomputer 70 reads the expected value code 24 directly from the expected value external storage section 80 and compares the generated code 21 with the expected value code 24.

As described above, according to the semiconductor device of this embodiment, in which the components of the digital video data test device 1 in Embodiment 1 are incorporated, the easiness of testing can be improved. Also, since the expected value external storage section 80 is provided outside the semiconductor device 5, and the embedded microcomputer 70 provided in place of the comparison section 13 reads the expected value code 24 from the expected value external storage section 80 and compares the generated code 21 with the read expected value code 24, increase in the area of the semiconductor device 5 can be further suppressed.

### Embodiment 11

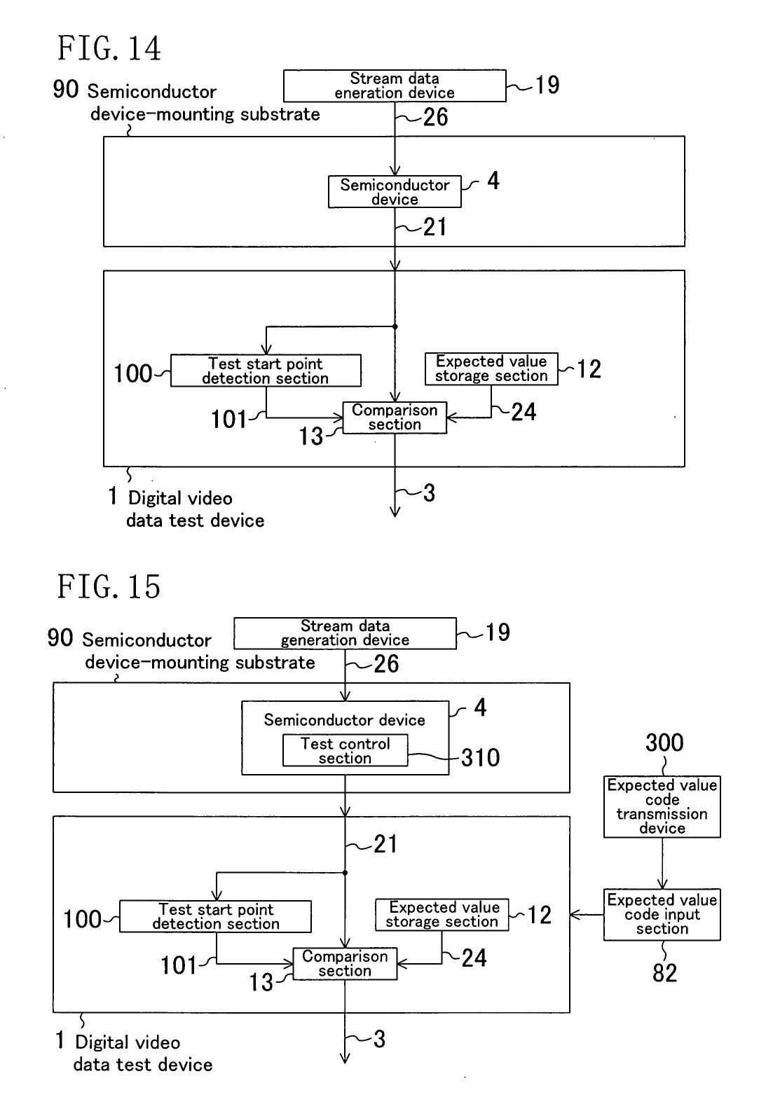

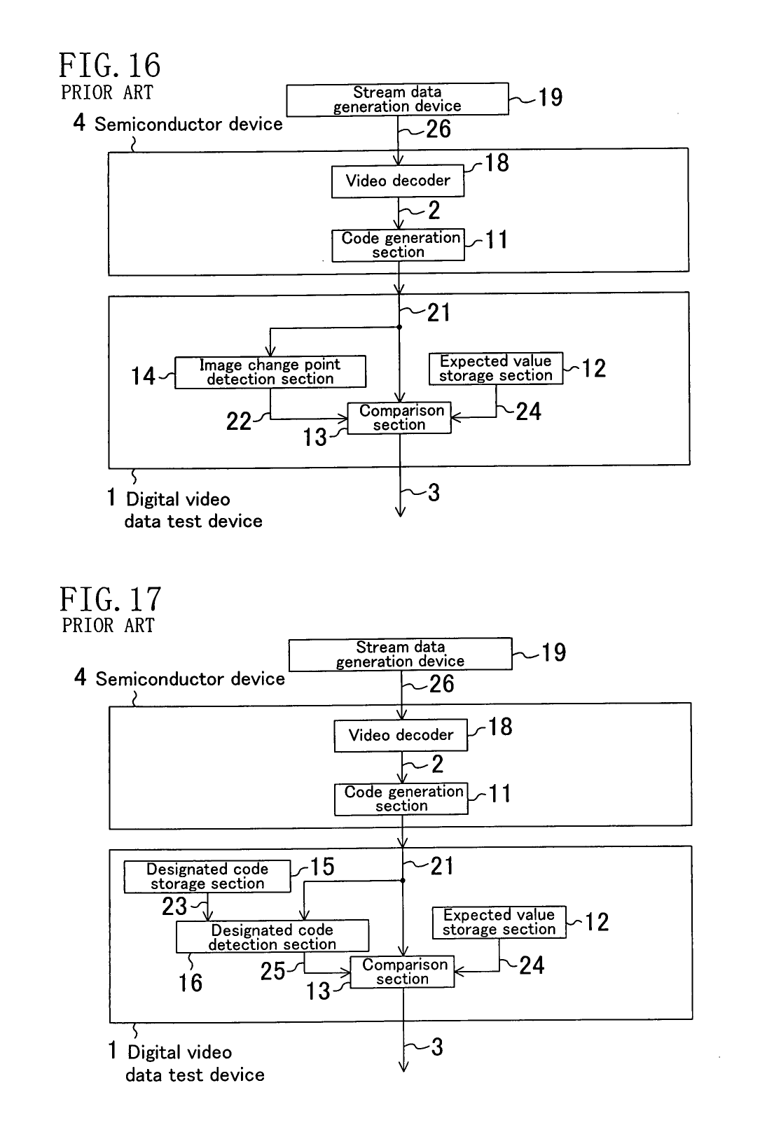

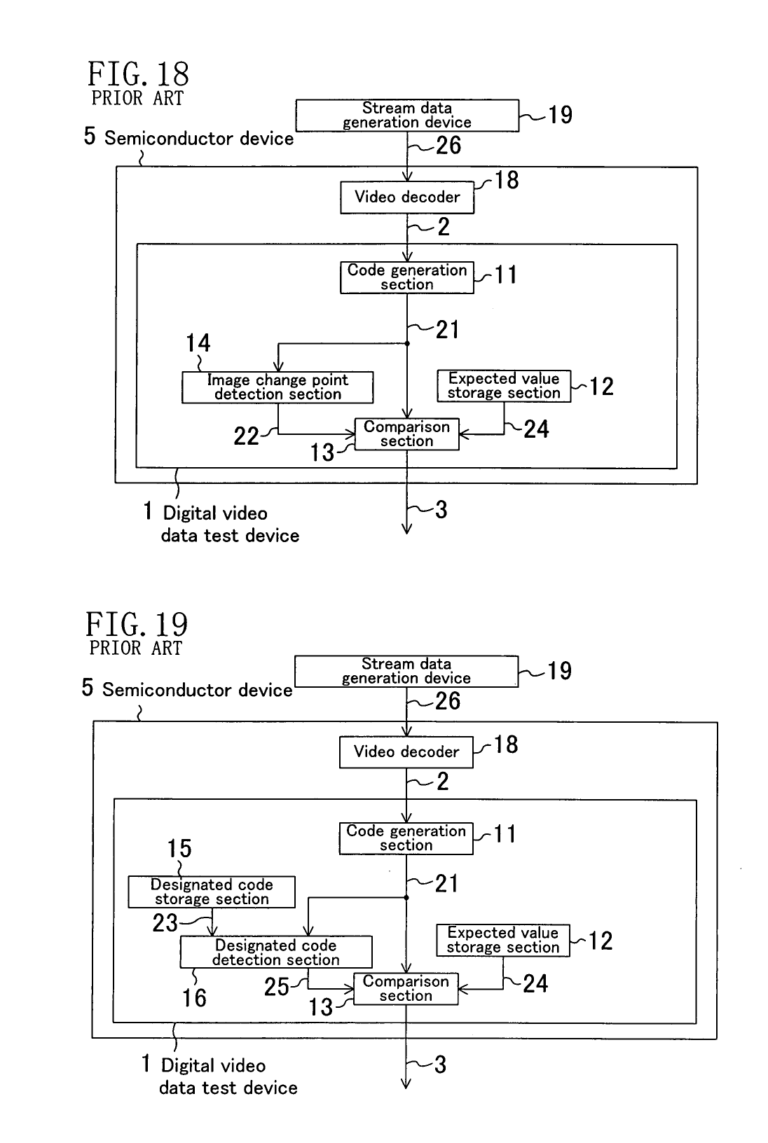

FIG. 14 is a block diagram showing the entire configuration of a digital video data test system of Embodiment 11 of the present invention.

The digital video data test system of this embodiment is different from that of Embodiment 1 described above in that the semiconductor device 4 is mounted on a substrate (semiconductor device-mounting substrate) 90 and thus in testing of the semiconductor device 4, the entire of the semiconductor device-mounting substrate 90 is also tested. The other part of the configuration is the same as that of Embodiment 1. The same components are therefore denoted by the same reference numerals and only the point different from Embodiment 1 will be described.

As shown in FIG. 14, the semiconductor device 4 is mounted on the semiconductor device-mounting substrate 90. In testing of digital video data using the digital video data test system described above, the generated code 21 is inputted into the digital video data test device 1 via the semiconductor device-mounting substrate 90. The other part of the operation is the same as that in Embodiment 1, and thus description thereof is omitted here.

As described above, in the digital video data test system of this embodiment, testing of the semiconductor device 4 including transmission routes on the semiconductor device-mounting substrate 90 can be made. Thus, a product substrate for digital AV equipment, for example, can be tested simultaneously with the semiconductor device.

### Embodiment 12

FIG. 15 is a block diagram showing the entire configuration of a digital video data test system of Embodiment 12 of the present invention.

The digital video data test system of this embodiment is different from that of Embodiment 11 described above in that an expected value code input section 82 is provided outside the digital video data test device 1 and that an expected value code transmission device 300 and a test control section 310 are further provided. The other part of the configuration is the same as that of Embodiment 11. The same components are therefore denoted by the same reference numerals and only the point different from Embodiment 11 will be described.

In FIG. 15, the test control section 310 starts/controls testing, the expected value code transmission device 300 can transmit a given expected value code, and the expected value code input section 82 receives the expected value code transmitted from the expected value code transmission device 300.

In testing of digital video data using the digital video data test system described above, an expected value code transmitted from the expected value code transmission device 300 is received by the expected value code input section 82, and then stored in the expected value storage section 12. The test control section 310 starts testing depending on the status of the system. The other part of the operation is the same as that in Embodiment 11, and thus description thereof is omitted here.

As described above, in the digital video data test system of this embodiment, home digital AV equipment, for example, may be provided with the expected value code input section 82. The expected value code input section 82 may receive an expected value code transmitted via data broadcasting or data communication, and the expected value storage section 12 may accumulate therein such received expected value codes, to thereby enable periodic self-diagnosis and the like of purchased products.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A digital video data test system comprising a semiconductor device and a digital video data test device, the semiconductor device comprising:
a code generation section for generating a generated code uniquely defined from inputted digital video data;
a clock frequency division section for dividing the frequency of a clock to generate a frequency-divided clock;
a timing signal generation section for generating a timing signal synchronizing with the frequency-divided clock using a sync signal in the digital video data; and
a code holding section for outputting the generated code in synchronization with the timing signal and the frequency-divided clock,
the semiconductor device outputting the timing signal, the generated code and the frequency-divided clock externally, and
the digital video data test device, receiving the timing signal, the generated code and the frequency-divided clock from the semiconductor device, comprising:
an image change point detection section for analyzing the generated code generated by the code generation section to detect an image change point at which an image represented by the digital video data temporally changes;
an expected value storage section for storing therein an expected value code; and
a comparison section for starting comparison between the generated code and the expected value code at and after the time point of detection of the image change point,
the digital video data test device testing the semiconductor device by processing the generated code.

2. The system of claim 1, wherein the semiconductor device further comprises a phase initialization section for initializing the phase of the frequency-divided clock every occurrence of specific timing defined by the timing signal, and
the phase initialization section sets the signal level of the frequency-divided clock to be the same level as that immediately before the initialization during at least a half cycle of the clock from immediately after the initialization.

3. The system of claim 1, wherein the semiconductor device further comprises a code generation initialization section for initializing the code generation section in synchronization with the timing signal, and
the code generation initialization section initializes the code generation section with an initial value reflecting digital video data in an initialization cycle.

4. The system of claim 1, wherein the semiconductor device further comprises a generated code holding section for holding the generated code until outputting the generated code, and
when a plurality of code generation sections exist, the generated code holding section sequentially holds generated codes generated by the respective code generation sections in synchronization with the timing signal and the frequency-divided clock signal.

5. The system of claim 1, wherein the semiconductor device further comprises a test timing initialization section for initializing timing of occurrence of test timing indicating the timing at which the generated code is compared with the expected value code, in the timing signal, every occurrence of field timing indicating the timing on a field-by-field basis in the timing signal.

6. The system of claim 1, wherein the digital video data test device further comprises:
a field-specific code generation section for generating a field-specific code from the inputted generated code every occurrence of test timing in the timing signal; and
a field-specific code comparing section for comparing a field-specific code generated in the current field with a field-specific code generated in the second immediately preceding field, among field-specific codes generated by the field-specific code generation section, and
the comparison section starts comparison between the generated code and the expected value code at the time point of detection of disagreement between the two field-specific codes.

7. The system of claim 1, wherein the semiconductor device is mounted on a substrate, and the generated code is transmitted from the semiconductor device to the digital video data test device via the substrate.

8. The system of claim 7, further comprising:
an expected value code transmission device for transmitting a given expected value code;
an expected value code input section for receiving the expected value code from outside; and
a test control section for executing testing at designated timing.

9. A digital video data test system comprising a semiconductor device and a digital video data test device, the semiconductor device comprising:
a code generation section for generating a generated code uniquely defined from inputted digital video data;
a clock frequency division section for dividing the frequency of a clock to generate a frequency-divided clock;
a timing signal generation section for generating a timing signal synchronizing with the frequency-divided clock using a sync signal in the digital video data; and
a code holding section for outputting the generated code in synchronization with the timing signal and the frequency-divided clock,
the semiconductor device outputting the timing signal, the generated code and the frequency-divided clock externally, and
the digital video data test device, receiving the timing signal, the generated code and the frequency-divided clock from the semiconductor device, comprising:
a designated code storage section for storing therein a designated code;
a designated code detection section for detecting agreement between the generated code generated by the code generation section and the designated code;
an expected value storage section for storing therein an expected value code; and
a comparison section for starting comparison between the generated code and the expected value code at and after the time point of detection of agreement between the generated code and the designated code,
the digital video data test device testing the semiconductor device by processing the generated code.

10. The system of claim 9, wherein the semiconductor device further comprises a phase initialization section for initializing the phase of the frequency-divided clock every occurrence of specific timing defined by the timing signal, and
the phase initialization section sets the signal level of the frequency-divided clock to be the same level as that immediately before the initialization during at least a half cycle of the clock from immediately after the initialization.

11. The system of claim 9, wherein the semiconductor device further comprises a code generation initialization section for initializing the code generation section in synchronization with the timing signal, and
the code generation initialization section initializes the code generation section with an initial value reflecting digital video data in an initialization cycle.

12. The system of claim 9, wherein the semiconductor device further comprises a generated code holding section for holding the generated code until outputting the generated code, and
when a plurality of code generation sections exist, the generated code holding section sequentially holds generated codes generated by the respective code generation sections in synchronization with the timing signal and the frequency-divided clock signal.

13. The system of claim 1, wherein the semiconductor device further comprises a test timing initialization section for initializing timing of occurrence of test timing indicating the timing at which the generated code is compared with the expected value code, in the timing signal, every occurrence of field timing indicating the timing on a field-by-field basis in the timing signal.

14. The system of claim 9, wherein the digital video data test device further comprises:
a field-specific code generation section for generating a field-specific code from the inputted generated code every occurrence of test timing in the timing signal; and
a designated field-specific code holding section for holding a designated field-specific code, and
the comparison section starts comparison between the generated code and the expected value code at the time point of detection of agreement between the field-specific code and the designated field-specific code.

15. The system of claim 9, wherein the semiconductor device is mounted on a substrate, and the generated code is transmitted from the semiconductor device to the digital video test device via the substrate.

16. The system of claim 15, further comprising:
an expected value code transmission device for transmitting a given expected value code;
an expected value code input section for receiving the expected value code from outside; and
a test control section for executing testing at designated timing.

17. A semiconductor device comprising:
a code generation section for generating a generated code uniquely defined from inputted digital video data;
a clock frequency division section for dividing the frequency of a clock to generate a frequency-divided clock;
a timing signal generation section for generating a timing signal synchronizing with the frequency-divided clock using a sync signal in the digital video data;
a code holding section for outputting the generated code in synchronization with the timing signal and the frequency-divided clock;
an image change point detection section for analyzing the generated code generated by the code generation section to detect an image change point at which an image represented by the digital video data temporally changes;
an expected value storage section for storing therein an expected value code;
an embedded microcomputer for executing read of the expected value code into the expected value storage section; and
a comparison section for starting comparison between the generated code and the expected value code at and after the time point of detection of the image change point.

18. The device of claim 17, wherein the embedded microcomputer serves as the comparison section.

19. The device of claim 17, wherein the embedded microcomputer serves as the comparison section, and
the embedded microcomputer reads the generated code and the expected value code and compares the generated code with the expected value code.

20. A semiconductor device comprising:
a code generation section for generating a generated code uniquely defined from inputted digital video data;
a clock frequency division section for dividing the frequency of a clock to generate a frequency-divided clock;
a timing signal generation section for generating a timing signal synchronizing with the frequency-divided clock using a sync signal of the digital video data;
a code holding section for outputting the generated code in synchronization with the timing signal and the frequency-divided clock;
a designated code storage section for storing therein a designated code;
a designated code detection section for detecting agreement between the generated code generated by the code generation section and the designated code;
an expected value storage section for storing therein an expected value code;
an embedded microcomputer for executing read of the expected value code into the expected value storage section; and
a comparison section for starting comparison between the generated code and the expected value code at and after the time point of detection of agreement between the generated code and the designated code.

21. The device of claim 20, wherein the embedded microcomputer serves as the comparison section.

22. The device of claim 20, wherein the embedded microcomputer serves as the comparison section, and
the embedded microcomputer reads the generated code and the expected value code and compares the generated code with the expected value code.
